(19) United States
(12) Patent Application Publication
(10) Pub. No.: US 2018/0001893 A1
(43) Pub. Date: Jan. 4, 2018

(54) AUTOMATED VEHICLE ACCELERATION MANAGEMENT SYSTEM

(71) Applicant: DELPHI TECHNOLOGIES, INC., TROY, MI (US)

(72) Inventors: JUNQING WEI, BRIDGEVILLE, PA (US); WENDA XU, PITTSBURGH, PA (US); JARROD M. SNIDER, PITTSBURGH, PA (US)

(21) Appl. No.: 15/198,598

(22) Filed: Jun. 30, 2016

(51) Int. Cl. B60W 30/16; G08G 1/16; B60W 30/09; B60W 30/18

(52) U.S. Cl. CPC B60W 30/16; B60W 30/18145; G08G 1/166; B60W 30/09; B60W 30/18154; B60W 2720/106; B60W 2550/10

(57) ABSTRACT

An acceleration management system for operating an automated vehicle includes a navigation-device, an object-detector, and a controller. The navigation-device is used to determine a travel-path of a host-vehicle. The object-detector is used to determine when an other-vehicle will intersect the travel-path of the host-vehicle. The controller is in communication with the object-detector and the navigation-device. The controller is configured to select an acceleration-profile for the host-vehicle that avoids interference with the other-vehicle, and operate the host-vehicle in accordance with the acceleration-profile.

### TECHNICAL FIELD OF INVENTION

This disclosure generally relates to an acceleration management system for operating an automated vehicle, and more particularly relates to a system that selects an acceleration-profile for a host-vehicle that avoids interference with an other-vehicle when a travel-path of the host-vehicle and the other-vehicle intersect.

### BACKGROUND OF INVENTION

It is known that slow acceleration of a host-vehicle from a stop helps to save fuel. However, if acceleration is too slow the host-vehicle may interfere with the travel of an other-vehicle, possibly causing the other-vehicle to slow-down and then accelerate back to a desired speed, which undesirably increases fuel consumption by the other-vehicle. It is also known that too-fast acceleration by a host-vehicle may result in an unpleasant or uncomfortable travel experience for passengers traveling in the host-vehicle.

### SUMMARY OF THE INVENTION

In accordance with one embodiment, an acceleration management system for operating an automated vehicle is provided. The system includes a navigation-device, an object-detector, and a controller. The navigation-device is used to determine a travel-path of a host-vehicle. The object-detector is used to determine when an other-vehicle will intersect the travel-path of the host-vehicle. The controller is in communication with the object-detector and the navigation-device. The controller is configured to select an acceleration-profile for the host-vehicle that avoids interference with the other-vehicle, and operate the host-vehicle in accordance with the acceleration-profile.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of an acceleration management system in accordance with one embodiment;

FIG. 2 is a traffic-scenario encountered by the system of FIG. 1 in accordance with one embodiment.

### DETAILED DESCRIPTION

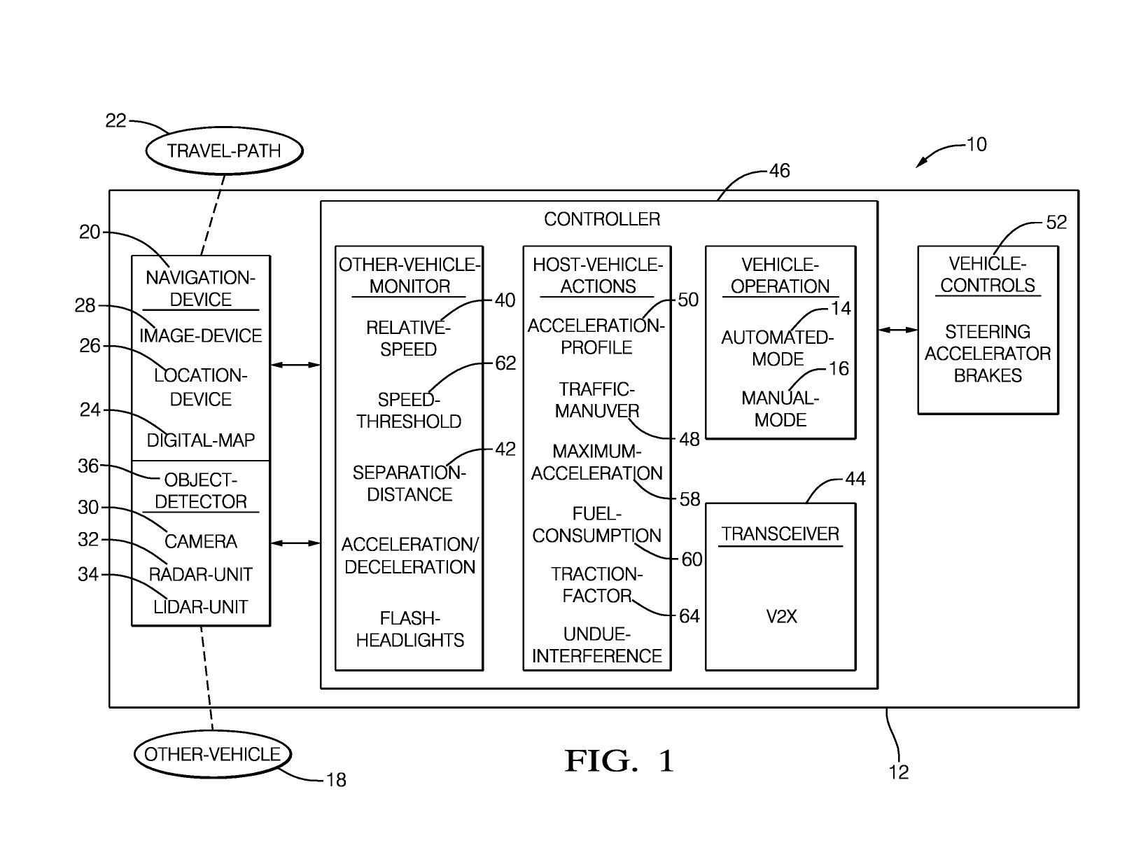

FIG. 1 illustrates a non-limiting example of an acceleration management system 10, hereafter referred to as the system 10, which is suitable for use by an automated vehicle, for example a host-vehicle 12. The examples presented herein are generally directed to instances when the host-vehicle 12 is being operated in an automated-mode 14, i.e. a fully autonomous mode, where a human operator (not shown) of the host-vehicle 12 does little more than designate a destination to operate the host-vehicle 12. However, it is contemplated that the teachings presented herein are useful when the host-vehicle 12 is operated in a manual-mode 16 where the degree or level of automation may be little more than providing steering advice to the human operator who is generally in control of the steering, accelerator, and brakes of the host-vehicle 12, i.e. the system 10 assists the human operator as needed to reach the destination and/or avoid interference and/or a collision with, for example, an other-vehicle 18.

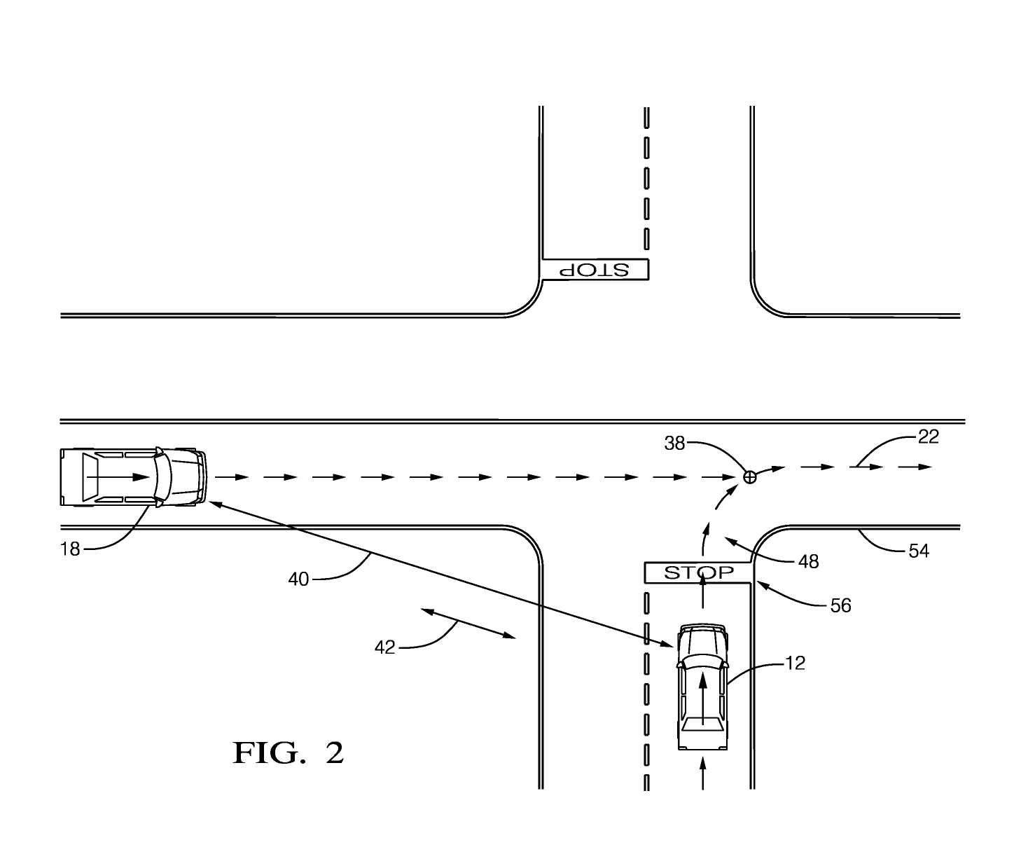

The system 10 includes a navigation-device 20 used to determine a travel-path 22 (i.e. travel-route, navigation-path, etc.; also see FIG. 2) of a host-vehicle 12 to a destination (not shown). That is, the navigation-device 20 may determine a route on a digital-map 24 that the host-vehicle 12 is supposed to follow to the destination, and/or determine where to steer the host-vehicle 12 along a roadway 54 so that the host-vehicle 12 is appropriately located on the roadway 54 relative to, for example, lane markings, curbs, traffic-signs, etc.

In order to determine where the host-vehicle 12 is located on the digital-map 24, the navigation-device 20 may include a location-device 26 such as a global-position-system (GPS) receiver (not shown). Alternatively, or in combination with the location-device 26, the navigation-device 20 may include an image-device 28 (e.g. a camera 30, a radar-unit 32, a lidar-unit 34, or any combination thereof) used to detect relatively permanent objects proximate to the host-vehicle 12 that are indicated on the digital-map 24 (e.g. traffic-signals, buildings, etc.), and determine a relative-location relative to those objects in order to determine where the host-vehicle 12 is located on the digital-map 24. This process is sometimes referred to as map-localization, as will be recognized by those in the art. It is also contemplated that the functions of (or information provided by) the navigation-device 20 may be all or in part by way of vehicle-to-infrastructure (V2I) communications, vehicle-to-vehicle (V2V) communications, and/or vehicle-to-pedestrian (V2P) communications, which may be generically labeled as V2X communications. Accordingly, the system 10 may include a transceiver 44 to enable such communications.

The function of the image-device 28 may be provided by, but not limited to, a camera 30, a radar-unit 32, a lidar-unit 34, or any combination thereof, which may also be shared with an object-detector 36 used to detect the relative-location of the other-vehicle 18, and determine when and/or an intersection-point 38 (FIG. 2) where the other-vehicle 18 will intersect the travel-path 22 of the host-vehicle 12. In order to determine the intersection-point 38 and the relative timing of when the host-vehicle 12 and the other-vehicle 18 will arrive at the intersection-point 38, the object-detector 36 may be used by the system 10 to determine, for example, a relative-speed 40 and/or separation-distance 42 of the other-vehicle 18 relative to the host-vehicle 12. As above, it is also contemplated that the functions of (or information provided by) the object-detector 36 may be by way of V2X communications. Accordingly, the system 10 may include a transceiver 44 to enable such communications.

The system 10 may include a controller 46 in communication with the object-detector 36 and the navigation-device 20. The communication may be by way of, but not limited to, wires, wireless-communication, or optical-fiber as will be recognized by those in the art. The controller 46 may include a processor (not specifically shown) such as a microprocessor or other control circuitry such as analog and/or digital control circuitry including an application specific integrated circuit (ASIC) for processing data as should be evident to those in the art. The controller 46 may include memory (not specifically shown), including non-volatile memory, such as electrically erasable programmable read-only memory (EEPROM) for storing one or more routines, thresholds, and captured data. The one or more routines may be executed by the processor to perform steps to determine where and when interference with the travel of the other-vehicle 18 may be the result of the host-vehicle 12 performing a traffic-maneuver 48 such as, but not limited to, turning onto the roadway 54 in front of the other-vehicle 18, as illustrated in FIG. 2.

As part of deciding whether or not a traffic-maneuver 48 is executed, the controller 46 is configured to select an acceleration-profile 50 for the host-vehicle 12 that avoids undue interference with the other-vehicle 18. As used herein, the acceleration-profile 50 describes or quantifies the planned and possibly variable acceleration-rate of the host-vehicle 12 used to accelerate the host-vehicle 12 from some present-speed to some desired-speed. The acceleration-profile 50 may be further selected based on any expected steering-maneuvers (e.g. turning a corner) that may be performed while accelerating to the desired-speed. By way of example and not limitation, when the host-vehicle 12 accelerates from a stop and immediately turns a corner 56 as illustrated in FIG. 2, it may be preferable for the comfort of passengers and safe operation of the host-vehicle to use a relatively slow acceleration-rate of, for example one-point-five meters-per-second-per-second (1.5 m/ŝ2) while turning, and then increase the acceleration-rate to, for example, four meters-per-second-per-second (4 m/ŝ2) if the increased acceleration-rate is needed to avoid undue interference with the other-vehicle 18.

As used herein, avoiding interference with the host-vehicle 12 may be generally interpreted to mean avoiding any action by the host-vehicle 12 that would require the other-vehicle 18 to take some action to avoid a collision. By way of example and not limitation, if the other-vehicle had to change lanes and/or decelerate to avoid a collision with the host-vehicle 12, then there is interference. In some situations when, for example, traffic is relatively heavy, i.e. traffic-density is high, a decision to execute the traffic-maneuver 48 may be made based on whether or not undue interference would result rather than basing the decision on avoiding any sort of interference of any kind. For example, if the other-vehicle 18 were required to decelerate less that ten percent (10%) to avoid a collision, or decelerate less that ten kilometers-per-hour (10 kph) from the present speed of the other-vehicle 18, then that level of deceleration would not be deemed to be undue interference. That is, the controller 46 may be configured to initiate the traffic-maneuver 48 when the acceleration-profile 50 causes interference that requires the other-vehicle 18 to reduce speed by less than a speed-threshold 62 to avoid a collision with the host-vehicle 12, where the speed-threshold 62 may be 10% or 10 kph, for example.

If no interference is predicted, or the interference is not deemed to be undue interference, i.e. not an excessive amount of interference, the controller 46 may also be configured to operate the host-vehicle 12 in accordance with the acceleration-profile 50 using the vehicle controls 52. By way of example and not limitation, the acceleration-profile may be selected to have relatively slow acceleration, e.g. two meters-per-second-per-second (2 m/s\textcircled{}2), to minimize the fuel-consumption 60 by the host-vehicle 12 and provide a comfortable travel experience for occupants of the host-vehicle 12. However, the acceleration-profile 50 must have sufficiently fast acceleration to avoid undue interference with the other-vehicle 18.

It is recognized that a maximum-acceleration 58 of the host-vehicle 12 is limited by at least the performance ability of the host-vehicle 12 itself. However, an embodiment is envisioned where the maximum-acceleration 58 of the acceleration-profile 50 is determined based on a user-preference. That is, if the operator (not shown) of the host-vehicle 12 would prefer to wait rather than have the host-vehicle 12 accelerate as fast as possible, the system 10 is configured so the operator can specify the maximum-acceleration 58 to be used under all circumstances, except possibly an emergency circumstance where violating that user-specified limit can help to avoid a collision. Regardless of the user specifying a reduced value for the maximum-acceleration 58, the controller 46 may be configured to wait to initiate the traffic-maneuver 48 when the acceleration-profile 50 will not be effective to avoid interference with the other-vehicle 18.

In another embodiment of the system 10, it is envisioned that the system 10 will be configured to determine or receive a traction-factor 64 of the travel-path 12, and determine the maximum-acceleration 58 of the acceleration-profile 50 based on the traction-factor 64. For example, the transceiver 44 may receive V2X communications that slippery road conditions have been detected by a vehicle that previously traveled the roadway 54. Alternatively, when the host-vehicle 12 was stopping as it approached the stop-sign as illustrated in FIG. 2; the braking-system of the host-vehicle 12 may have detected a low-traction condition. Alternatively, the camera 30 may detect water on the roadway 54 and/or detect the stop-sign painted on the roadway 54 and the system 10 may be configured to recognize that these conditions can also lead to a low value for the traction-factor 64 which will reduce the ability of the host-vehicle 12 to accelerate.

The object-detector 36 (e.g. the radar-unite 32, the lidar-unit 34, or V2X communications) may detect sudden acceleration or deceleration by the other-vehicle 18, which may also be considered when determining a go/no-go status for the traffic-maneuver, and/or selecting the acceleration-profile 50. It is also contemplated that the camera 30 may be used to detect when the other-vehicle 18 flashes its headlights which may be an indication that the other-vehicle 18 is going to decelerate and is inviting the host-vehicle 12 to proceed with entering the roadway 54.

Accordingly, an acceleration management system (the system 10), a controller 46 for the system 10, and a method of operating the system 10 is provided. The system 10 seeks to operate the host-vehicle 12 in a manner that minimized interference with the travel of the other-vehicle 18 when the travel-path 22 of the host-vehicle 12 and the other vehicle will intersect.

While this invention has been described in terms of the preferred embodiments thereof, it is not intended to be so limited, but rather only to the extent set forth in the claims that follow.

We claim:

1. An acceleration management system for operating an automated vehicle, said system comprising:
a navigation-device used to determine a travel-path of a host-vehicle;
an object-detector used to determine when an other-vehicle will intersect the travel-path of the host-vehicle; and
a controller in communication with the object-detector and the navigation-device, said controller configured to select an acceleration-profile for the host-vehicle that avoids interference with the other-vehicle, and operate the host-vehicle in accordance with the acceleration-profile.

2. The system in accordance with claim 1, wherein the acceleration-profile is selected to minimize fuel-consumption by the host-vehicle.

3. The system in accordance with claim 1, wherein a maximum-acceleration of the acceleration-profile is determined based on a user-preference.

4. The system in accordance with claim 1, wherein the system is configured to determine a traction-factor of the travel-path, and determine a maximum-acceleration of the acceleration-profile based on the traction-factor.

5. The system in accordance with claim 1, wherein the controller is configured to wait to initiate a traffic-maneuver when the acceleration-profile will not be effective to avoid interference with the other-vehicle.

6. The system in accordance with claim 1, wherein the controller is configured to initiate a traffic-maneuver when the acceleration-profile causes interference that requires the other-vehicle to reduce speed by less than a speed-threshold to avoid a collision.
